(19) United States
(12) Patent Application Publication
(10) Pub. No.: US 2008/0308655 A1
(43) Pub. Date: Dec. 18, 2008

(54) Trigger Sprayer Structure with Children Protection Functions

(76) Inventor: Jian Jun Yuan, Yuyao (CN)

Correspondence Address: GLOBAL IP SERVICES, 7285 W. Eagle Court, Winton, CA, 95388, US

(21) Appl. No.: 11/854,684

(22) Filed: Sep. 13, 2007

(30) Foreign Application Priority Data
Jun. 13, 2007 (CN) 200720110622.5

(51) Int. Cl. B05B 9/01

(52) U.S. Cl. 239/526

(57) ABSTRACT

This utility model relates to a trigger sprayer structure with children protection functions, which added a mechanism for limiting the revolving of the head cap on the basis of the former spray gun structure, said mechanism includes a stop groove formed on the head cap as an integral, said stop groove is provided with a elastic joint with the head cap, a pressing component for manual pressing, said trigger is provided with a stop block correspondingly, said stop block insertion component being inserted in the stop groove of said cap. This structure can prevent children from easily revolving the head cap, thus preventing children from using the spray gun containing hazardous liquid.

### CROSS REFERENCE TO RELATED PATENT APPLICATION

This patent application claims the priority of the Chinese patent application No. 200720110622.5 with a filing date of Jun. 13, 2007.

### FIELD OF THE INVENTION

This patent of utility model relates to a liquid spray gun, and more particularly to a structure of liquid spray gun with children protection functions.

### BACKGROUND OF THE INVENTION

At present, a regular liquid spray gun recognized by the public consists of the nozzle, the spin mechanism, the gun body, the trigger, the piston, the spring, the shroud and the retainer etc. Press the trigger by hand to push the piston, the water will flow from the water passage of the gun body (then the ball valve will drop back and the water will not flow back to the retainer) through the sprinkler head, the flow can be adjusted into mist or stream sprayed from the nozzle. When the trigger is released, the spring will return to the original state, thus driving the piston to return, the negative pressure is generated and the bead will jump up, the suction due to the negative pressure makes the water flow from the sucker into the piston, and then the effect of spraying is achieved by repetition of the procedure above. However, because most of the spray guns use chemical preparations as the liquid, some of them are serious hazardous to human health, the adults can read the instruction to know how to take preventive measures while children don't, which may cause serous danger. Regular spray guns cannot satisfactorily solve this problem.

### SUMMARY OF THE INVENTION

The technical problem to be solved by this utility model is to provide a trigger sprayer structure with children protection protections to prevent children from injuries from contacting the chemicals in the bottle by opening the bottle or priming the trigger sprayer.

This utility model adopts the following technical solutions to solve the aforesaid problem: the trigger sprayer structure with children protection functions includes a gun body, a piston, a shield mounted on the gun body, a head cap mounted on the head of gun body, a sprinkler head inside the head cap, a sucker component connected at the lower part of the gun body as well as a trigger pivotally fixed on the gun body, said spray gun is featured by that a clipping mechanism for limiting the revolving of the head cap is equipped between said head cap and said trigger or said shield.

Said clipping mechanism includes a stop groove integrally fixed on a pressing component for manual pressing, the pressing component has a elastic joint for the connection with said head cap, said trigger is provided with a stop block correspondingly, said stop block insertion component is inserted in the stop groove of the pressing component for position limitation against the trigger.

said stop groove is the interval formed by 2 symmetric pins on the inner wall of the pressing component, said stop block on said trigger is formed by the interval between 2 concaves formed on the trigger.

An anti-dropping structure is provided between said gun body and said shield, said anti-dropping structure including a barb and gussets formed on said gun body and protrusions formed on the shield to be engaged with said barb and gusset of said gun body.

Compared with existing technologies, this utility model has the following advantages: this utility model is provided with a clipping mechanism between the head cap and the trigger for limiting the revolving of the head cap, enabling it to be turned on only by adults instead of children when it's turned off and put aside, besides, it has simple structure and convenient operation.

### BRIEF DESCRIPTION OF THE DRAWINGS

FIG. 1 is a structural representation of an embodiment of this utility model.

FIG. 2 is a 3D exploded view of an embodiment of this utility model.

FIG. 3 is an outline drawing of an embodiment of this utility model.

FIG. 4 is the first 3D exploded view of the head cap.

FIG. 5 is a second 3D exploded view of the head cap.

FIG. 6 is a 3D exploded view of the gun body.

FIG. 7 is a structure representation of the shield.

FIG. 8 is a drawing showing the assembly structure of the gun body and the shield.

### DETAIL DESCRIPTION OF THE INVENTION

Now, description will be given below of an embodiment of this utility model with reference to the accompanying drawings.

A trigger sprayer structure with children protection functions according to this utility model is provided with a clipping mechanism on the basis of a traditional spray gun for preventing the head cap from revolving, which prevents children from easily revolving the head cap, thus protecting children from injuries by using the spray gun containing hazardous liquid.

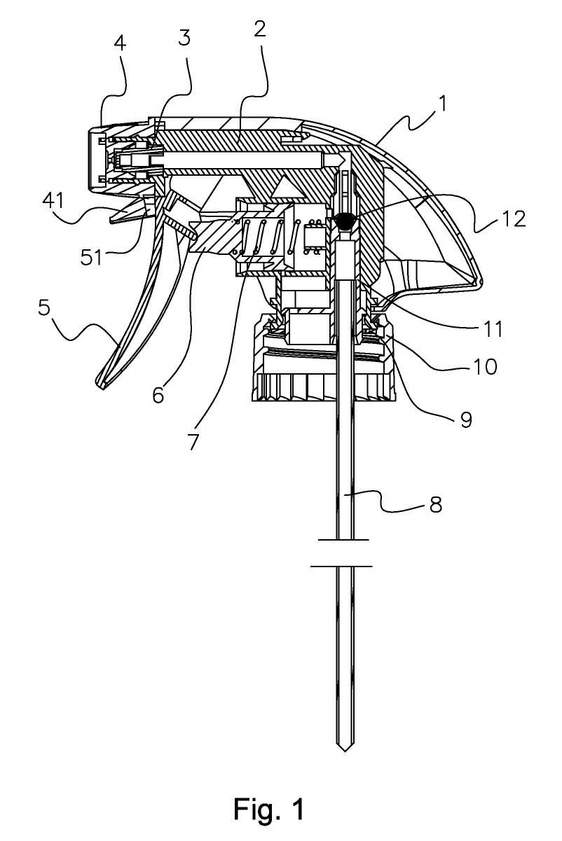

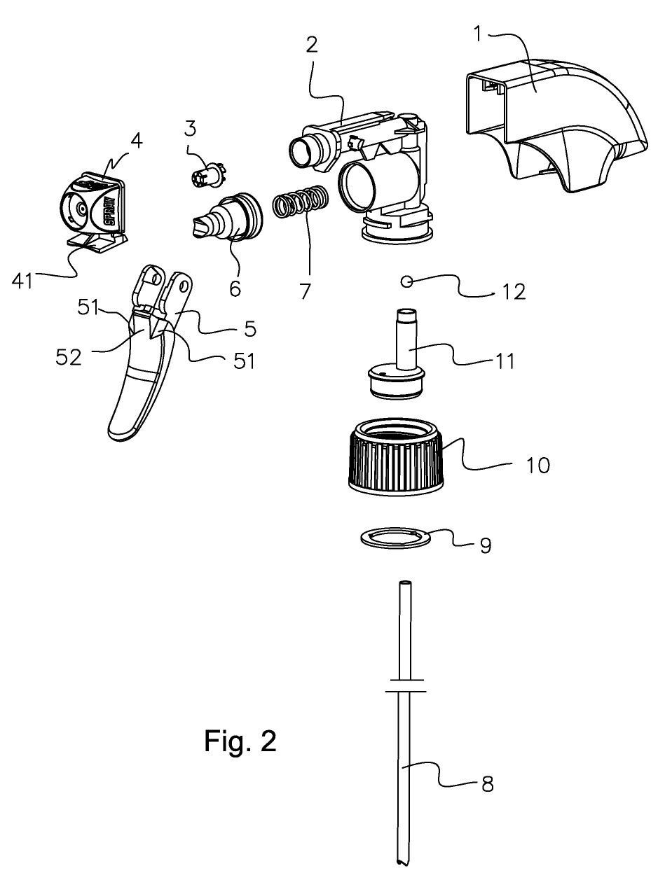

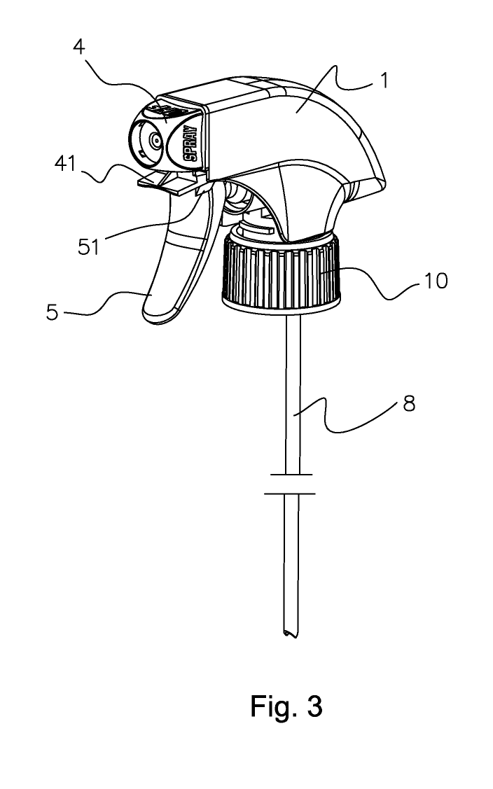

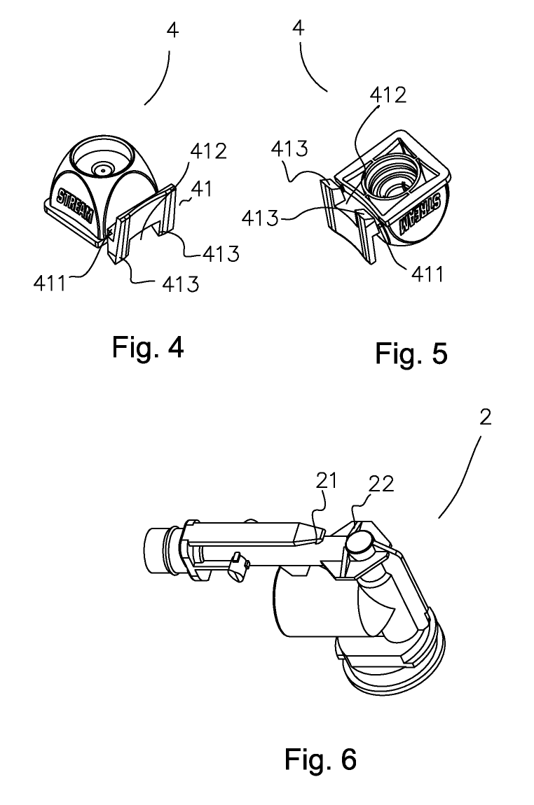

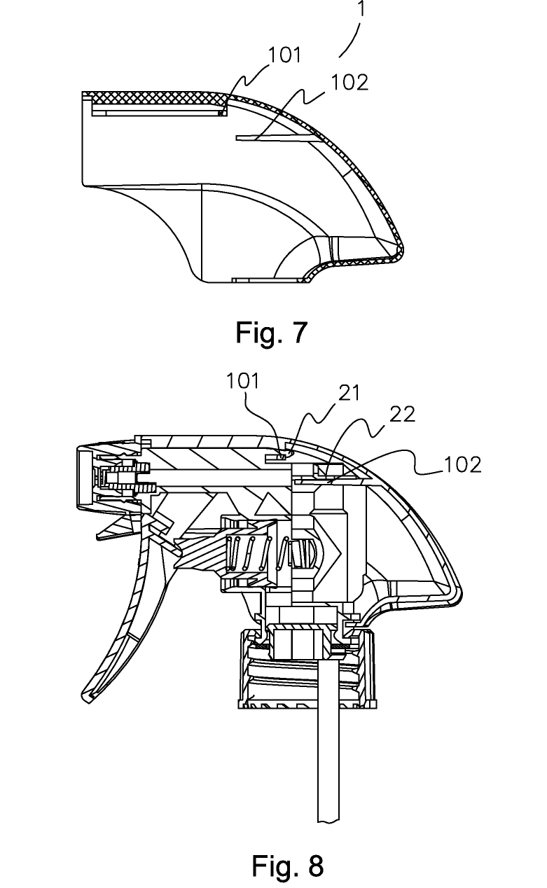

As shown in FIGS. 1-8, this trigger sprayer includes a gun body 2 of a regular spray gun, a piston 6 mounted in the piston hole of the gun body, a spring 7, a shield 1 fixed in the gun body, a head cap 4 mounted on the head of gun body, a sprinkler head 3 inside the head cap, a sucker component connected at the lower part of gun body and a trigger 5 pivotally fixed on the gun body, etc, where, gun body 2 and the shield 1 are both integral injection molded components, and in order to improve the strength of both and the effect of engagement, the barb 21 and the reinforcing gussets 22 are respectively formed at the top and both sides of the gun body, the protrusions 101, 102 are formed on said shield 1 respectively for engagement with said barb 21 and said reinforcing gussets 22, the engagement of said corresponding components fastens the combination between both as shown in FIGS. 6, 7 and 8.

The sucker component connected at the bottom of the gun body includes a sucker 8, a cover 10, a gasket 9, a bead base 11 and a bead 12, etc, where, to prevent children from turning on the cover 10, said cover 10 is provided with reverse thread inside for engagement with the opening of the container, which prevents children from opening the cover and contact with hazardous liquid, and thus reinforcing the protecting function.

Said clipping mechanism is provided between the head cap 4 and the trigger 5 (or the shield 1), and more specifically, a stop groove 412 is provided on the pressing component 41 of the head cap 4, said pressing component 41 and said head cap 4 forms an integral, which has the elastic joint 411 for connection with the head cap 4, the pressing component 41 for manual pressing and the stop groove 412 for position limitation against the trigger 5 or the shield 1, said stop groove 412 is the interval formed by a pair of symmetric pins 413 extending from inside of the pressing component 41, said stop groove 412 of cap be turned in relation to the head cap 4 through the elastic joint 411 connected with the head cap 4 under external force can return to the original position due to the flexibility of the plastic. Two concaves 51 form integrally on said trigger corresponding to the 2 pins 413 of the stop groove on the head cap 4. The interval between the 2 concaves 51 forms the stop block 52 engaged with said stop groove 412. After assembly of the spray gun, the 2 pins 413 of the stop groove on the head cap are inserted in the concaves 51 of the trigger and the stop block 52 is inserted in the stop groove 412 correspondingly, preventing the head cap 4 from revolving. Only by pressing the stop block 52 to disengage the 2 pins 413 of the stop groove 412 with the stop block 52 of the trigger can the head cap 4 be revolved.

During operation of this trigger sprayer, when the head cap 4 is in OFF status, the 2 pins 413 of the head cap 4 are set in the 2 concaves 51 of the trigger, in this case, if you revolve the head cap 4 rightwards or leftwards, the pins 413 cannot be revolved as are stopped by the trigger and the shield, and the liquid outlet of the sprinkler head 3 is sealed by the head cap, the liquid cannot be sprayed out from outlet of the head cap 4, thus achieving the effect of safety protection for children.

When the pressing component 41 is pressed down, thus offsetting the pins 413 forth till they are not stopped by the stop block 52 of the trigger, they you can turn the head cap 4 to switch the head cap 4 to the ON position, in this case, the water exit between the head cap 4 and the sprinkler head 3 will be opened, press the trigger 5 to drive the piston 6 to extrude the water out, as there is a bead 12, the water will not flow back to the sucker 8 and will directly be sprayed out from the head cap 4 through the water exit of the gun body 2 and the sprinkler head 3. When the trigger 5 is released, the spring 7 and the piston 6 will return, driving the bead 12 jump up due to the pressure difference, I this case, as the pressure inside the piston 6 is smaller that the air pressure, the water will flow from the sucker 8 into the piston 6 under the hydraulic pressure, and the spraying effect is achieved through repetition of the procedure above.

In this embodiment, the clipping mechanism is provided between the head cap 4 and the trigger 5. Also the said clipping mechanism can be set between the head cap 4 and the shield 1. It is very similar. The stop block can be easily formed on the shield 1 engaged with the stop groove 412 on the cap 4.

What is claimed is:

1. A trigger sprayer structure with children protection functions comprising a gun body (2), a piston (6), a shield (1) fixed on said gun body, a head cap (4) mounted on the head of said gun body, a sprinkler head (3) provided inside the head cap, a sucker component connected to the lower part of said gun body and a trigger (5) pivotally mounted on said gun body, wherein a clipping mechanism for preventing children to revolve said head cap is provided between said head cap (4) and said trigger (5) or said shield (1).

2. The trigger sprayer structure with children protection functions according to claim 1, wherein said clipping mechanism includes a stop groove (412) integrally fixed on a pressing component (41) for manual pressing, the pressing component (41) has a elastic joint (411) for the connection with said head cap (4), said trigger (5) is provided with a stop block (52) correspondingly, said stop block (52) insertion component is inserted in the stop groove (412) of the pressing component (41) for position limitation against the trigger (5).

3. The trigger sprayer structure with children protection functions according to claim 1, wherein said stop groove (412) is the interval formed by 2 symmetric pins (413) on the inner wall of the pressing component (41), said stop block (52) on said trigger is formed by the interval between 2 concaves (51) formed on the trigger.

4. the trigger sprayer structure with children protection functions according to claim 1, wherein an anti-dropping structure is provided between said gun body (2) and said shield (1), including a barb (21) and gussets (22) formed on said gun body, and protrusions (101, 102) formed on said shield (1) for engagement with said barb (21) and gussets (22) on said gun body.

5. The trigger sprayer structure with children protection functions according to claim 1, wherein the sucker component connected at the bottom of the gun body includes a cover (10), said cover (10) is provided with reverse thread inside for engagement with the opening of the container.
